(19) United States
(12) Patent Application Publication
(10) Pub. No.: US 2018/0129214 A1
(43) Pub. Date: May 10, 2018

(54) DETERMINING A TRAJECTORY FOR A VEHICLE

(71) Applicant: VOLKSWAGEN AKTIENGESELLSCHAFT, Wolfsburg (DE)

(72) Inventors: Michael DÜRING, Braunschweig (DE); Markus BELKNER, Steinheim (DE)

(21) Appl. No.: 15/572,221

(22) PCT Filed: Apr. 15, 2016
(86) PCT No.: PCT/EP2016/058315

§ 371 Date: Nov. 7, 2017

(30) Foreign Application Priority Data
May 12, 2015 (DE) 10 2015 208 790.5

(51) Int. Cl. G05D 1/02; G06K 9/00; G05D 1/00

(52) U.S. Cl. CPC G05D 1/0212; G06K 9/00798; G05D 2201/0213; G06K 9/00805; G05D 1/0088

(57) ABSTRACT

A method for automatically determining a trajectory for a vehicle, wherein the trajectory connects a starting point, which corresponds to the current position of the vehicle, to a target point. The trajectory determination process includes determining multiple intermediate points; determining at least a first partial trajectory, which connects the starting point to one of the intermediate points; determining multiple second partial trajectories, which connect the target point to one of the intermediate points in each case; determining the trajectory by selecting one of the at least one first partial trajectories and one of the second partial trajectories; actuating at least one component of the vehicle based on the determined trajectory; and ending at least two partial trajectories at each intermediate point.

### PRIORITY CLAIM

This patent application is a U.S. National Phase of International Patent Application No. PCT/EP2016/058315, filed 15 Apr. 2016, which claims priority to German Patent Application No. 10 2015 208 790.5, filed 12 May 2015, the disclosures of which are incorporated herein by reference in their entireties.

### SUMMARY

Illustrative embodiments relate to the determination of trajectories, particularly of evasive trajectories for an evasive maneuver, to make way with a vehicle in front of an obstacle, for example, substantially automatically.

### BRIEF DESCRIPTION OF THE DRAWINGS

The disclosed embodiments are described in detail below with reference to the figures.

FIG. 1 shows multiple possible trajectories between a starting point and a destination;

FIG. 2 shows the trajectories depicted in FIG. 1 being stored as a graph theory tree;

FIG. 3 shows the flowchart for a disclosed method; and

FIG. 4 schematically shows a disclosed system.

### DETAILED DESCRIPTION

DE 10 2004 027 250 A1 discloses a method and an apparatus for assisted control of a motor vehicle. This involves determining a desired path of travel with a starting point and a destination. If an actual position differs from the desired path of travel, a difference arc and a first and a second correction arc are used to output a corrected desired path of travel.

DE 10 2004 027 983 A1 describes the identification of lane change processes performed by another vehicle. This involves determining trajectories of other vehicles to take these as a basis for describing a lane change behavior of these other vehicles. In this case, a lane change variable is determined using a probabilistic network in which observation variables and/or the variances thereof are combined with one another.

DE 100 36 276 A1 describes an automatic braking and steering system, wherein, in the event of an obstacle in the path of travel of the vehicle, an evasive path for bypassing the obstacle is automatically taken according to a stored evasion strategy. In this case, if it is not possible to find a collision-free evasive path, the evasive path is chosen from among multiple alternatives.

DE 10 2007 058 538 A1 discloses a method for controlling a hazard situation in traffic in which a number of vehicles are involved. In this case, trajectories for evasion are determined for each vehicle and an alternative for the trajectory is selected in a coordinated manner.

DE 10 2011 081 159 A1 describes the performance of an evasive maneuver by a motor vehicle, wherein an optimum trajectory section for the evasive maneuver is ascertained by a nonlinear program.

DE 10 2013 214 225 A1 discloses the ascertainment of an evasive trajectory for a vehicle in relation to an obstacle. In this case, state data are taken as a basis for determining a manipulated variable for influencing the movement of the vehicle along the evasive trajectory.

DE 10 2006 034 254 A1 describes the performance of an evasive maneuver by a motor vehicle. This involves determining a path for the evasive maneuver. The path is provided by a sigmoid, the shape of which is determined by a parameter. A starting point at which the evasive maneuver is started is determined on the basis of the ascertained path.

In the event of collisions between vehicles and obstacles or other vehicles, accidents are still caused with a high level of personal and/or material damage. An example that can be cited is risky overtaking maneuvers on country roads or approaching the end of a queue on a freeway too quickly. According to the prior art, an evasive trajectory is calculated in such cases to assist the driver, on the basis of this evasive trajectory, to avoid an accident as a result or at least to moderate the consequences of an accident.

Known methods involve identification of an obstacle prompting an evasive trajectory to be determined for the vehicle to automatically guide the vehicle past the obstacle along this evasive trajectory. If a further obstacle is now identified during the automatic journey along the evasive trajectory, many known methods do not allow a further reaction thereto or else recalculation of the evasive trajectory is too time-consuming, which means that a collision with the further obstacle normally cannot be prevented.

Disclosed embodiments improve the determination of a trajectory or evasive trajectory for a vehicle.

According to the disclosed embodiments, this is achieved by a method for automatically determining a trajectory and by a system.

Within the context of the present disclosure, a method for automatically determining a trajectory for a vehicle is provided. This involves the trajectory to be determined being used to connect a starting point corresponding to the current position of the vehicle to a destination. The disclosed method comprises the following operations:
Determining multiple intermediate points.
Determining one or more first partial trajectories. In this case, the first partial trajectory connects the starting point to one of the intermediate points if only one first partial trajectory is determined. Alternatively, each of these first partial trajectories connects the starting point to a respective other instance of the intermediate points if multiple first partial trajectories are determined.
Determining multiple second partial trajectories, each of these second partial trajectories connecting the final point to a respective other instance of the intermediate points.
Determining the trajectory by virtue of the first partial trajectory being chosen if there is only a first partial trajectory and by virtue of a first partial trajectory being chosen from the first partial trajectories if there are multiple first partial trajectories and by virtue of a second partial trajectory being chosen from the second partial trajectories. The chosen first and chosen second partial trajectories then form at least one respective part of the determined trajectory.
Actuating a component (e.g., the steering) of the vehicle on the basis of the determined trajectory.

According to the disclosure, each partial trajectory connects either
the starting point to an intermediate point or
two intermediate points or
an intermediate point to the destination.

By virtue of not only the trajectory to be determined but also, by way of example, at least one second partial trajectory being determined that is not part of the determined trajectory, this second partial trajectory can be used in the case of replanning without having to calculate or determine it beforehand. It is therefore possible for replanning or recalculation of the trajectory to be performed more quickly than is possible according to the prior art.

Generally, each intermediate point is defined such that two or more partial trajectories end at each intermediate point. To be able to perform replanning at an intermediate point, however, at least three (i.e., three or more) partial trajectories must end at this intermediate point. It is thus possible for each intermediate point, according to at least one disclosed embodiment, also to be defined such that an intermediate point is an intermediate point only if at least three partial trajectories end at it.

According to the disclosed embodiments, further partial trajectories can be determined that each connect two of the intermediate points. The trajectory to be determined can then be assembled not only from the first partial trajectory and the second partial trajectory but also, in addition, from one or more of these further partial trajectories.

The more intermediate points and the more partial trajectories are on hand, the more options exist for determining the trajectory. The more options that exist for determining the trajectory, the better the trajectory to be determined can meet prescribed constraints (e.g., no collision with an obstacle, smallest possible acceleration forces exerted on the vehicle).

Each of the partial trajectories is determined before the trajectory itself is determined. In other words, the first partial trajectory/trajectories, the second partial trajectories and the further partial trajectories are determined first before the trajectory is determined on the basis of these partial trajectories.

By way of example, the intermediate points can be arranged as grid points on a grid particularly between the starting point and the destination. If partial trajectories that each connect adjacent intermediate points are then determined, there are firstly numerous options (for instance, numerous partial trajectories) available for the trajectory that is to be determined and, secondly, numerous partial trajectories exist for every journey on the determined trajectory to be able to quickly replan the determined trajectory on the basis of these partial trajectories.

If, for example, on a journey by the vehicle on the determined trajectory, it is detected that this trajectory is unnavigable (because there is on this trajectory an obstacle that has not yet been detected hitherto), the trajectory can be quickly redetermined or replanned. To this end, a different partial trajectory is chosen for an intermediate point that is on an as yet unnavigated part of the currently determined trajectory that is ahead of the unnavigable part of the trajectory, so that the redetermined trajectory is navigable.

As a result of the prior determination of the partial trajectories, a different path to the destination can be chosen at virtually any intermediate point (having more than two partial trajectories). As a result, the disclosed method is much more quickly able, in the event of an obstacle suddenly appearing, to redetermine the trajectory such that the new determined trajectory goes around the obstacle than if the partial trajectories themselves still had to be determined beforehand, as is the case in the prior art.

The intermediate points are on a road or on navigable ground that the vehicle is currently on. In this case, one or more of the intermediate points may be on hand on the left-hand or right-hand lateral edge of this navigable ground as seen in the direction of travel of the vehicle.

By virtue of the intermediate points being arranged on the navigable ground, it is normally very easy to make certain that the course of the partial trajectories determined using these intermediate points is likewise on the navigable ground.

Some of the intermediate points or each of the intermediate points may be defined not only by their/its location on the road or on the navigable ground but also by a vehicle orientation. In this case, the vehicle orientation determines the respective orientation of the vehicle that is present when the vehicle moves along a partial trajectory that begins or ends at the respective intermediate point. A partial trajectory can be connected to another partial trajectory only if one partial trajectory ends at the same intermediate point at which the other partial trajectory begins, the intermediate point also being defined by the vehicle orientation. In other words, one partial trajectory can be connected to the other partial trajectory only if the vehicle orientation at the end of one partial trajectory corresponds to the vehicle orientation at the beginning of the other partial trajectory.

By taking into consideration the vehicle orientation in the intermediate points, the determination of the trajectory can be better matched to reality.

Besides by the location and the vehicle orientation, an intermediate point can also be defined by a time and/or by a speed. In this case, the time of the intermediate point determines the time at which the vehicle arrives at the intermediate point when the vehicle travels along a partial trajectory ending at the intermediate point, or the time at which the vehicle sets off from the intermediate point when the vehicle travels along a partial trajectory beginning at the intermediate point. In a similar manner, the speed of the intermediate point determines the speed at which the vehicle arrives at the intermediate point when the vehicle travels along a partial trajectory ending at the intermediate point, or the speed at which the vehicle sets off from the intermediate point when the vehicle travels along a partial trajectory beginning at the intermediate point. As in the case of the vehicle orientation, it also holds for the time or the speed that a partial trajectory can be connected to another partial trajectory only if the time or the speed at the end of one partial trajectory corresponds to the time or the speed at the beginning of the other partial trajectory.

According to a disclosed embodiment, every possible trajectory (i.e., every trajectory that the vehicle can navigate from the starting point to the destination) is stored as a graph theory tree. In this case, the root of the tree corresponds to the starting point and the leaves of the tree or each leaf of the tree correspond(s) to the destination. The inner nodes of the tree correspond to the intermediate points, or each inner node of the tree corresponds to one of the intermediate points. In this case, according to a disclosed embodiment, only those intermediate points at which at least three partial trajectories end correspond to an inner node.

The disclosed storage as a graph theory tree allows the following disclosed procedure:

In a first operation, an optimum trajectory is determined among all the trajectories stored as the tree, for example, on the basis of a cost function. This trajectory is taken until the vehicle reaches the destination or until it is identified, for example, on the basis of an obstacle, that the remaining part of the trajectory is unnavigable. In the latter case, the trajectory can be replanned by using a subtree of the tree whose root corresponds to the intermediate point that the vehicle is currently at.

Since this subtree is already on hand, the replanning of the trajectory can be carried out extremely quickly.

According to the disclosed embodiments, some of the partial trajectories or every partial trajectory can be defined not only by its initial point (starting point or intermediate point) and its final point (intermediate point or destination) but also by further parameters. These further parameters can comprise a longitudinal acceleration and a transverse acceleration of the vehicle over time, for example, to which the vehicle is subject to navigate the respective partial trajectory from its initial point to its final point.

The use of further parameters allows the determination of the trajectory to be optimized further.

According to the disclosed embodiments, it is also possible for the surrounding area of the vehicle to be automatically detected, in which case this detected surrounding area is then taken as a basis for determining the destination.

Specifically during fully automatic driving of a vehicle, the destination should also be prescribed automatically.

Furthermore, the vehicle can also be guided fully automatically (i.e., without any assistance from the driver) along the determined trajectory.

The present disclosure will be explained in detail once again below on the basis of an exemplary embodiment.

In this regard, it is assumed that a vehicle on a straight road approaches a stationary vehicle in its lane. The disclosed method is used to plan trajectories to continue the journey. To this end, the current position of the vehicle at the current time is defined as a starting point, which is described not only by the position described by the coordinates x0 and y0 but also by the current speed v0, the current acceleration a0 and the current vehicle orientation heading0. The destination determined is a point in the lane that the vehicle is supposed to reach in four seconds, for example. To determine or plan multiple trajectories that each connect the starting point to the destination, intermediate points (interpolation points, grid points) are used for the planning. These intermediate points can be connected by navigable partial trajectories (e.g., sigmoids, polynomials) using a vehicle model (e.g., point model, point mass model, single track model, multitrack model, full vehicle model). The polynomial used in this regard can be a fifth-order polynomial, for example, as indicated in equations (1) to (3) below:

$$\begin{matrix} {y}^{″} ( x ) = {{c}_{0} ( x - {x}_{0} )}^{3} + {{c}_{1} ( x - {x}_{0} )}^{2} + {c}_{2} ( x - {x}_{0} ) + {c}_{3} & ( 1 ) \\ {y}^{′} ( x ) = \frac{{c}_{0}}{4} {( x - {x}_{0} )}^{4} + \frac{{c}_{1}}{3} {( x - {x}_{0} )}^{3} + \frac{{c}_{2}}{2} {( x - {x}_{0} )}^{2} + {c}_{3} ( x - {x}_{0} ) + {c}_{4} & ( 2 ) \\ y ( x ) = \frac{{c}_{0}}{20} {( x - {x}_{0} )}^{5} + \frac{{c}_{1}}{12} {( x - {x}_{0} )}^{4} + \frac{{c}_{2}}{6} {( x - {x}_{0} )}^{3} + \frac{{c}_{3}}{2} {( x - {x}_{0} )}^{2} + {c}_{4} ( x - {x}_{0} ) + {c}_{5} & ( 3 )\end{matrix}$$

In this case, x corresponds to the position of the vehicle in the x direction and y(x) indicates the position of the vehicle in the y direction as a function of x. To be able to determine the navigability of the respective partial trajectory or trajectory, a prerequisite may be observance of the ‘circle of forces’ condition, and further parameters, such as the delays in the brake or actuator system or steering and gear ratio, the speed of steering angle change or maximum accelerations or decelerations are taken into consideration. In equations (1) to (3), the parameters c₀ to c₅ need to be determined. To this end, it can be assumed, by way of example, that the vehicle has a vehicle orientation (heading) of 0 (i.e., travels in the direction of the road and there are no curves (i.e., the vehicle does not perform cornering)) at the starting point, each intermediate point and the final point. The following conditions according to equations (4) to (7) then apply.

y(x=x₀)=y₀ (4)

y(x=x_{ZP})=y_{ZP} (5)

y(x=x₀)=y′(x=x_{ZP})=0 (6)

y′(x=x₀)=y′(x=x_{ZP})=0 (7)

Among these conditions, the parameters c₃, c₄ and c₅ are each equal to 0 and the parameters c₀, c₁ and c₂ are obtained according to the following equations (8) to (10).

$$\begin{matrix}{c}_{0} = 120 \cdot \frac{{y}_{ZP} - {y}_{0}}{{( {x}_{ZP} - {x}_{0} )}^{5}} & ( 8 ) \\ {c}_{1} = - 180 \cdot \frac{{y}_{ZP} - {y}_{0}}{{( {x}_{ZP} - {x}_{0} )}^{4}} & ( 9 ) \\ {c}_{2} = 60 \cdot \frac{{y}_{ZP} - {y}_{0}}{{( {x}_{ZP} - {x}_{0} )}^{3}} & ( 10 )\end{matrix}$$

In this case, the index 0 describes the current position of the vehicle (i.e., the starting point or the current intermediate point), and the index ZP describes the next intermediate point or destination. The possible trajectories can be assigned any desired speed profile, but the conditions of the chosen vehicle model need to be satisfied. There are therefore numerous resultant trajectories that each represent a connection from the starting point to the destination. From these trajectories, it is then possible to choose an optimum trajectory by a cost function that describes e.g., the comfort, safety and efficiency of the respective trajectory. The disclosed embodiments adapt to a changing traffic situation (e.g., detecting a new obstacle on the currently chosen trajectory) can be mastered without recalculating the partial trajectories, which saves valuable computation time.

Within the context of the present disclosure, a system for determining a trajectory that is used to connect a starting point to a destination for a vehicle is also provided. The disclosed system comprises one or more components of the vehicle and control mechanisms. The control mechanisms are configured to determine the starting point as the current position of the vehicle and to determine the destination. The control mechanisms are further configured to determine multiple intermediate points, to determine one or more first partial trajectories and to determine multiple second partial trajectories. In this case, the first partial trajectory (trajectories) connect(s) the starting point to a respective one of the intermediate points, while the second partial trajectories each connect one of the intermediate points to the destination. The control mechanisms are further configured to determine the trajectory by selecting the or one of the first partial trajectories and one of the second partial trajectories and to actuate the component(s) of the vehicle on the basis of the determined trajectory.

In this case, the benefits of the disclosed system correspond to the benefits of the disclosed method that have been explained previously in detail, so that a repetition is dispensed with at this juncture.

According to at least one disclosed embodiment, the control mechanisms comprise first communication mechanisms that are arranged inside the vehicle and processing mechanisms that, in turn, have second communication mechanisms. In this case, the processing mechanisms are arranged outside the vehicle and configured to determine the partial trajectories. The first communication mechanisms and the second communication mechanisms are configured to transmit the partial trajectories to the vehicle.

In this disclosed embodiment, a central unit outside the vehicle can calculate the trajectories to then transmit them to the vehicle as a tree, for example. As a result, the vehicle is able, even without trajectory planning capabilities of its own or on the basis of insufficiently high-performance trajectory planning capabilities, to use the disclosed embodiments to quickly react to unknown surrounding areas.

Finally, a vehicle is provided that comprises a disclosed system.

According to the disclosure, braking maneuvers, evasive maneuvers or combined braking and evasive maneuvers to be carried out automatically are calculated by virtue of an overall maneuver (a trajectory) being assembled from a number of partial maneuvers (partial trajectories). To this end, the intermediate points or grid points that depict a grid arranged on the road form physical interpolation points for calculating these partial maneuvers or partial trajectories. The connections between the interpolation points (intermediate points, starting point and destination) and hence the partial trajectories can be determined by purely geometric description forms (e.g., polynomials, sigmoids), in which case a speed profile can then be calculated per partial trajectory according to the remaining force potential.

The disclosed embodiments allow collisions to be avoided even in the event of unforeseen changes (e.g., suddenly occurring obstacles). The further options (partial trajectories) already determined previously allow changes to the currently navigated trajectory to be made very quickly, which allows valuable time to be saved to avoid the collision.

In other words, the essential process engineering difference in comparison with known solutions is the once-only planning of possible evasive maneuvers (partial trajectories) that can be transferred to other evasive maneuvers (another trajectory) at branch points (intermediate points).

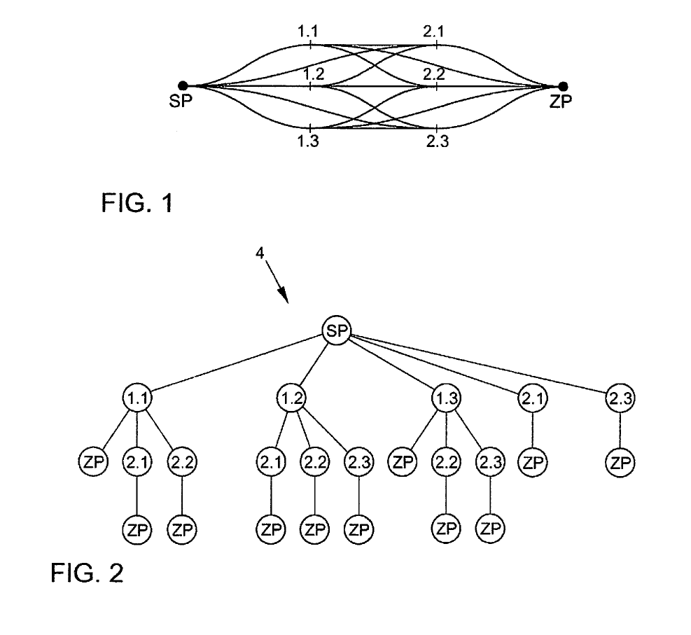

FIG. 1 depicts multiple possible trajectories between a starting point SP and a destination ZP. In this case, each of these trajectories is assembled from multiple partial trajectories, each partial trajectory connecting an initial point (i.e., the starting point or an intermediate point) to a final point (i.e., an intermediate point or the destination). The six intermediate points 1.1 to 2.3 are arranged between the starting point SP and the destination ZP in this case.

FIG. 2 depicts all the trajectories depicted in FIG. 1 stored as a graph theory tree 4. The root of the tree corresponds to the starting point SP and each leaf of the tree 4 corresponds to the destination ZP. Therefore, each branch of the tree that runs from the root SP to one of the leaves ZP corresponds to one of the possible trajectories depicted in FIG. 1.

It is assumed that a vehicle travels from the starting point SP to the destination ZP fully automatically on the previously determined trajectory SP-1.2-2.2-ZP, the vehicle being shortly behind the starting point. The vehicle now detects that there is an obstacle that has not been identified hitherto in proximity to the intermediate point 2.2, which means that a collision would occur if the vehicle were to continue to travel on the current trajectory. Since the vehicle is already on the partial trajectory SP-1.2, there still exist three possible trajectories from the intermediate point 1.2 to the destination ZP that are stored as a subtree whose root corresponds to the intermediate point 1.2. On the basis of a cost function, the evasive trajectory SP-1.2-2.1-ZP is now determined, so that the vehicle travels onto the partial trajectory 1.2-2.1 at the intermediate point 1.2 to travel to the destination ZP via the intermediate point 2.1, with the obstacle at the intermediate point 2.2 being bypassed.

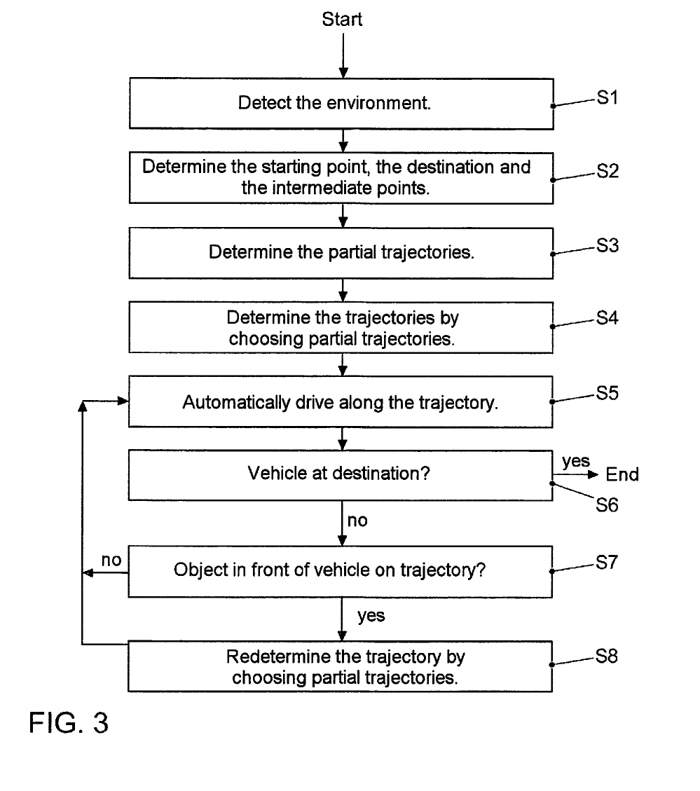

FIG. 3 shows the flowchart for a disclosed method.

In operation at S1, the environment of the vehicle is detected using one or more sensors of the vehicle. In the subsequent operation at S2, the starting point, the destination and intermediate points between the starting point and the destination are automatically determined. In this case, the starting point corresponds to the current position of the vehicle, and the destination is determined on the basis of the detected environment. To determine the intermediate points, a kind of grid can be arranged between the starting point and the destination on the road on which the vehicle travels. The grid points of this grid correspond to the intermediate points to be determined, with predefined points (e.g., at the edges of the road) also being able to be defined as intermediate points.

In operation at S3, the partial trajectories that each connect an initial point to a final point are determined. In this case, the initial point corresponds to the starting point or an intermediate point and the final point corresponds to an intermediate point or the destination. The partial trajectories are determined using a vehicle model with appropriate variations for the longitudinal acceleration and transverse acceleration. Each partial trajectory is what is known as a navigable partial trajectory, which means that the appropriate partial trajectory can be navigated using the vehicle. This in turn means that particular constraints for the circle of forces, steering gear ratio, engine characteristic curve, transmission characteristic curve, tire characteristic curve, delays in the actuator system (brakes, steering, acceleration) are taken into consideration when determining the respective partial trajectory.

The partial trajectories can now be used to store all the navigable trajectories as a tree. The root of the tree corresponds to the starting point, each leaf of the tree corresponds to the destination, and each node of the tree corresponds to an intermediate point. In this case, the same intermediate point may repeatedly be part of the same trajectory, which is the case when the vehicle travels forward and backward, for example. With the aid of this tree, a cost function, for example, is used in operation at S4 to determine the most favorable trajectory from the starting point to the destination, as a result of which the partial trajectories belonging to this trajectory are also determined.

In operation at S5, the vehicle automatically travels along this trajectory. If it is identified in operation at S6 that the vehicle is at the destination, the method ends, otherwise the method continues to operation at S7. If it is identified in operation at S7 that there is an obstacle or object on the trajectory in the direction of travel in front of the vehicle, the trajectory is redetermined in operation at S8 by choosing other partial trajectories. To this end, at the next node or intermediate point in the tree, a trajectory is determined that connects this intermediate point to the destination without there being a (hitherto known) obstacle on this determined trajectory. From operation at S7 or operation at S8, the method returns in each case to operation at S5, in which the vehicle automatically travels on the respectively determined trajectory.

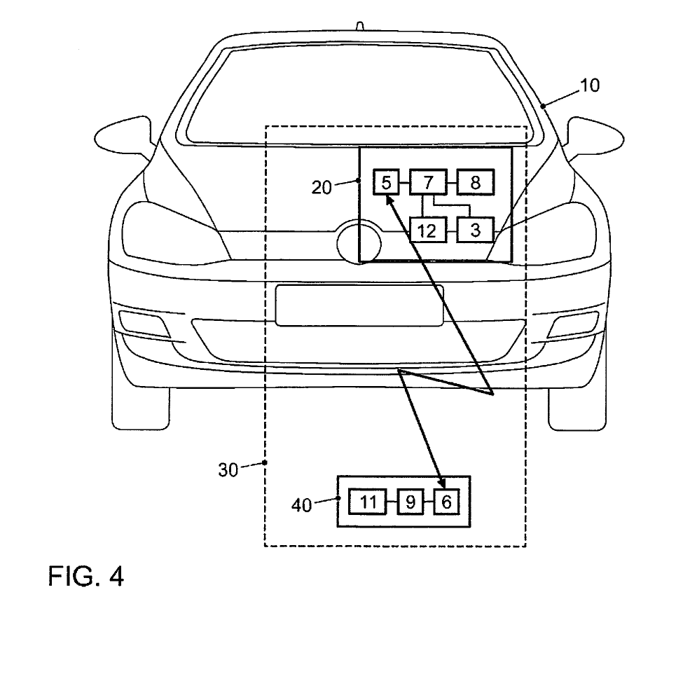

FIG. 4 schematically depicts a vehicle 10 and a system 30. The vehicle 10 comprises an apparatus 20. The apparatus 20 in turn comprises a controller 7, communication mechanism 5, a memory 8, a sensor 12 and a steering 3 of the vehicle 10. Using the sensor 12, the apparatus 20 detects an environment of the vehicle 10 to determine not only the starting point (as the current position of the vehicle 10), for example, but also the destination.

In regard to the apparatus 20, there exist two disclosed embodiments. According to the first disclosed embodiment, the apparatus 20 uses its controller 7 to determine all the possible navigable trajectories between the starting point and the destination itself and stores them as a tree in the memory 8. On the basis of these trajectories, the apparatus 20 uses a cost function, for example, to determine a trajectory that is then navigated by the vehicle 10 by virtue of the controller 7 automatically operating the steering 3 as appropriate. If the sensor 12 is used to detect that there is an obstacle on the currently determined trajectory, the apparatus 20 uses the trajectories stored in the memory 8 to determine a new trajectory that bypasses this obstacle. In this disclosed embodiment, the communication mechanisms 5 are not necessarily required, but can be used to capture additional information by radio from other road users, for example.

According to the second disclosed embodiment, there exists a system 30 that comprises not only the apparatus 20 but also a processing unit 40. The processing unit 40 comprises not only a controller 9 but also a memory 11 and communication mechanisms 6. In the second disclosed embodiment, the apparatus 20 uses its communication mechanisms 5 to transmit the starting point and the destination to the processing unit 40 via the communication mechanisms 6 by radio. The controller 9 of the processing unit 40 determines all the possible trajectories and transmits them as a tree by radio back to the apparatus 20, which stores these trajectories in its memory 8. The determination of the trajectory to be automatically navigated can then be performed by the apparatus 20, as in the first disclosed embodiment. The replanning for a new trajectory when an obstacle on the current trajectory is detected by the sensor 12 is also performed by the apparatus 20.

### LIST OF REFERENCE SYMBOLS

1.1-1.3 Intermediate point
2.1-2.3 Intermediate point
3 Steering
4 Graph theory tree
5, 6 Communication mechanisms
7, 9 Controller
8, 11 Memory
10 Vehicle
12 Sensor
20 Apparatus
30 System
40 Processing unit
SP Starting point
ZP Destination

1. A method for automatically determining a trajectory for a vehicle, which trajectory connects a starting point corresponding to a current position of the vehicle to a destination, the method comprising:
determining multiple intermediate points;
determining at least one first partial trajectory that connects the starting point to one of the intermediate points;
determining multiple second partial trajectories that connect the destination to the one of the intermediate points;
determining the trajectory based on one of the at least one of the multiple first partial trajectories and one of the multiple second partial trajectories; and
actuating at least one component of the vehicle based on the determined trajectory,
wherein at least two first partial trajectories end at each intermediate point.

2. The method of claim 1, wherein at least three first partial trajectories end at each intermediate point.

3. The method of claim 1, further comprising:
determining further partial trajectories that each connect two of the intermediate points; and
determining the trajectory based on the one first partial trajectory and the one of the multiple second partial trajectories as well as at least one further partial trajectory.

4. The method of claim 1, wherein each of the partial trajectories is determined before the trajectory is determined.

5. The method of claim 1, wherein, in response to detection, on a journey by the vehicle on the trajectory that the determined trajectory is unnavigable, the method further comprises redetermining the trajectory by choosing a different partial trajectory at an intermediate point that is on an, as yet, unnavigated part of the previously determined trajectory, so that the redetermined trajectory is navigable.

6. The method of claim 1, further comprising:
arranging the intermediate points on a road that the vehicle is on, and
arranging at least one of the intermediate points at a lateral edge of the road.

7. The method of claim 1, further comprising:
defining each of these intermediate points, at least for some of the intermediate points, not only by its location on a road that the vehicle is on but also by a vehicle orientation that the vehicle has when the vehicle travels along a partial trajectory that begins or ends at the respective intermediate point, and
wherein a partial trajectory that ends at an intermediate point with a location is connected only to another partial trajectory that begins at an intermediate point with the same location to form a trajectory if the vehicle orientation at the end of the partial trajectory corresponds to the vehicle orientation at the beginning of the other partial trajectory, so that the intermediate point at the end of the partial trajectory is the same intermediate point at which the other partial trajectory begins.

8. The method of claim 1, further comprising:
storing every possible trajectory as a graph theory tree;
wherein a root of the tree corresponds to the starting point,
wherein the leaves of the tree correspond to the destination, and
wherein the inner nodes of the tree correspond to the intermediate points.

9. The method of claim 1, wherein at least some of the partial trajectories are defined by their initial point as the starting point or one of the intermediate points and their final point as the destination or one of the intermediate points, and are also defined by a longitudinal acceleration and a transverse acceleration of the vehicle over time to move the vehicle from the initial point to the final point on the respective partial trajectory.

10. The method of claim 1, further comprising:
detecting a surrounding area of the vehicle; and
determining the destination based on the detected surrounding area.

11. The method of claim 1, wherein the vehicle is guided on the determined trajectory fully automatically.

12. A system for determining a trajectory for a vehicle, which trajectory is used to connect a starting point to a destination,
wherein the system comprises at least one component of the vehicle and controller,
wherein the controller is configured to determine the starting point as the current position of the vehicle and determine the destination,
wherein the controller determines multiple intermediate points to determine at least one first partial trajectory that connects the starting point to one of the intermediate points, to determine at least two second partial trajectories that connect the destination to a respective one of the intermediate points, to determine the trajectory by virtue of the controller choosing one of the at least one first partial trajectory and one of the second partial trajectories, and to actuate the at least one component based on the determined trajectory,
wherein at least two partial trajectories end at each intermediate point.

13. The system of claim 12,
wherein the controller comprises a first communication mechanism and processor having a second communication mechanism,
wherein the processor is arranged outside the vehicle,
wherein the first communication mechanism is arranged inside the vehicle,
wherein the processor determines the partial trajectories, and
wherein the first communication mechanism and the second communication mechanism transmit the partial trajectories to the vehicle.

14. The system of claim 12, wherein the system performs a method for automatically determining the trajectory for the vehicle, which trajectory connects the starting point corresponding to the current position of the vehicle to the destination, the method comprising:
determining multiple intermediate points;
determining at least one first partial trajectory that connects the starting point to one of the intermediate points;
determining multiple second partial trajectories that connect the destination to the one of the intermediate points;
determining the trajectory based on one of the at least one of the multiple first partial trajectories and one of the multiple second partial trajectories; and
actuating at least one component of the vehicle based on the determined trajectory,
wherein at least two first partial trajectories end at each intermediate point.

15. The system of claim 14, wherein at least three first partial trajectories end at each intermediate point.

16. The system of claim 14, wherein the method further comprises determining further partial trajectories that each connect two of the intermediate points, and determining the trajectory based on the one first partial trajectory and the one of the multiple second partial trajectories as well as at least one further partial trajectory.

17. The system of claim 14, wherein each of the partial trajectories is determined before the trajectory is determined.

18. The system of claim 14, wherein, in response to detection, on a journey by the vehicle on the trajectory, that the determined trajectory is unnavigable, the method further comprises redetermining the trajectory by choosing a different partial trajectory at an intermediate point that is on an, as yet, unnavigated part of the previously determined trajectory, so that the redetermined trajectory is navigable.

19. The system of claim 14, wherein the method further comprises arranging the intermediate points on a road that the vehicle is on, and arranging at least one of the intermediate points at a lateral edge of the road.

20. The system of claim 14, wherein the method further comprises defining each of these intermediate points, at least for some of the intermediate points, not only by its location on a road that the vehicle but also by a vehicle orientation that the vehicle has when the vehicle travels along a partial trajectory that begins or ends at the respective intermediate point, and
wherein a partial trajectory that ends at an intermediate point with a location is connected only to another partial trajectory that begins at an intermediate point with the same location to form a trajectory if the vehicle orientation at the end of the partial trajectory corresponds to the vehicle orientation at the beginning of the other partial trajectory, so that the intermediate point at the end of the partial trajectory is the same intermediate point at which the other partial trajectory begins.

21. The system of claim 14, wherein the method further comprises storing every possible trajectory as a graph theory tree, wherein a root of the tree corresponds to the starting point, wherein the leaves of the tree correspond to the destination, and wherein the inner nodes of the tree correspond to the intermediate points.

22. The system of claim 14, wherein at least some of the partial trajectories are defined by their initial point as the starting point or one of the intermediate points and their final point as the destination or one of the intermediate points, and are also defined by a longitudinal acceleration and a transverse acceleration of the vehicle over time to move the vehicle from the initial point to the final point on the respective partial trajectory.

23. The system of claim 14, wherein the method further comprises detecting a surrounding area of the vehicle and determining the destination based on the detected surrounding area.

24. The system of claim 14, wherein the vehicle is guided on the determined trajectory fully automatically.
